(19) United States
(12) Patent Application Publication
(10) Pub. No.: US 2015/0279524 A1
(43) Pub. Date: Oct. 1, 2015

(54) GAMMA RESISTOR ADJUSTING DEVICE, DRIVING CIRCUIT AND DISPLAY DEVICE

(71) Applicants: BOE TECHNOLOGY GROUP CO., LTD., Beijing (CN); HEFEI BOE OPTOELECTRONICS TECHNOLOGY CO., LTD., Hefei, Anhui (CN)

(72) Inventors: Xia Feng, Beijing (CN); Jian He, Beijing (CN); Jiacheng Huang, Beijing (CN)

(21) Appl. No.: 14/359,380

(22) PCT Filed: Aug. 22, 2013
(86) PCT No.: PCT/CN2013/082088

§ 371 Date: May 20, 2014

(30) Foreign Application Priority Data
Apr. 27, 2013 (CN) 201310153964.5

(51) Int. Cl. H01C 10/50; H01C 10/16; G09G 3/20

(52) U.S. Cl. CPC H01C 10/50; G09G 3/2007; H01C 10/16; G09G 2320/0276; G09G 2320/0673; G09G 2310/08

(57) ABSTRACT

A Gamma resistor adjusting device, a driving circuit, and a display device, the Gamma resistor adjusting device is applicable to a source driver integrated circuit, and includes: a built-in resistor string comprising a plurality of Gamma resistors connected in series, wherein the Gamma resistors can adjust resistance values thereof under the control of a control signal; a control signal generating unit for receiving internal resistance variation data including resistor adjustment information of each of the Gamma resistors and generating a control signal for each of the Gamma resistors according to the internal resistance variation data; and an adjusting unit for adjusting the resistance value of each of the Gamma resistors according to the generated control signal. The present disclosure can conveniently and efficiently adjust the Gamma curve of the display device and has a relatively low cost of implementation.

### TECHNICAL FIELD

The present disclosure relates to a field of display technique, in particular to a Gamma resistor adjusting device, a driving circuit, and a display device.

### BACKGROUND

At present, in order to simplify the circuit design on a printed circuit board or a flexible circuit board and meanwhile to save cost, a great many of display devices with small size adopt directly the design of build-in Gamma resistors in a source driver integrated circuit. However, if the built-in Gamma resistor is mismatched with the display panel, neither the display gray level of the display panel nor the Gamma curve is smooth, which causes the picture quality of the display panel poor.

As known, the Gamma curve of the display device can be adjusted by means of the design of external Gamma resistors. FIG. 1 shows a schematic diagram of a structure of external Gamma resistors as known in the art. In FIG. 1, AVDD is an analog voltage for supplying power to the Gamma resistor. The structure comprises 15 Gamma resistors (R1˜R15). Gamma voltage values of V1˜V14 can be adjusted by adjusting resistance values of the Gamma resistors, so as to adjust positive and negative gray-scale voltage values (corresponding to G0, G1, G16 . . . in FIG. 1 respectively) for the seven nodes of 0, 1, 16, 32, 48, 62, 63, so that the Gamma curve is adjusted. However, the aforesaid method can only adjust the gray-scale voltages for a small number of nodes, while a majority of the gray-scale voltages are controlled by the built-in Gamma resistors, and cannot be adjusted such that the picture quality cannot be improved apparently.

Also, the Gamma curve of the display device can be adjusted by changing the built-in Gamma resistors. However, it is needed to adopt different built-in Gamma resistors for different display panels, which is apt to cause too many versions of the source driver integrated circuit to manage easily.

### SUMMARY

Given that, the present disclosure provides a Gamma resistor adjusting device, a driving circuit, and a display device, which are capable of conveniently and efficiently adjusting the Gamma curve of the display device and has a relatively low cost on implementation.

In order to solve the above technical problem, according to one aspect of the present disclosure, there provides a Gamma resistor adjusting device comprising:

a built-in resistor string comprising a plurality of Gamma resistors connected in series, wherein the Gamma resistors can adjust resistance values thereof under the control of a control signal;

a control signal generating unit for receiving internal resistance variation data including resistor adjustment information of each of the Gamma resistors and generating a control signal for each of the Gamma resistors according to the internal resistance variation data;

an adjusting unit for adjusting the resistance value of each of the Gamma resistors according to the generated control signal.

Alternatively, the Gamma resistors further comprise: a base value resistor, a plurality of adjusting resistors and a plurality of control switches corresponding to the plurality of adjusting resistors, wherein the basic value resistor is connected in series with the plurality of adjusting resistors and each of the control switches is connected in parallel with the corresponding adjusting resistor; and the adjusting unit is further used for controlling the control switches to be switched on or off according to the generated control signal.

Alternatively, the number of the Gamma resistors connected in series is 2n+1, where n is gray level of the display panel.

Alternatively, the internal resistance variation data is obtained by simulating according to characteristics of a voltage-transmittance curve and a Gamma curve of the display panel.

Further, there provides a source driver integrated circuit according to another aspect of the present disclosure, comprising the above Gamma resistor adjusting device.

Further, there provides a display device according to another aspect of the present disclosure, comprising the above source driver integrated circuit.

Alternatively, the display device further comprises:

a storage unit connected to the source driver integrated circuit, for storing the internal resistance variation data and inputting the internal resistance variation data to the source driver integrated circuit when the display device operates.

Alternatively, the storage unit is connected to the source driver integrated circuit through an internal integrated circuit interface.

Alternatively, the display device further comprises:

a storage unit used for storing the internal resistance variation data;

a timing controller connected to the storage unit and the source driver integrated circuit, for outputting the internal resistance variation data input from the storage unit to the source driver integrated circuit when the display device operates.

Alternatively, the timing controller is connected to the source driver integrated circuit through an internal integrated circuit interface.

The embodiments of the present disclosure can obtain the following beneficial technical effects:

The resistance values of internal resistances of the source driver integrated circuit are set as adjustable structures, so that the internal resistances of the source driver integrated circuit are matched with the display panel in a better way and the Gamma curve is smoother thereby achieving a better effect of picture quality. Furthermore, the same source driver integrated circuit can be applicable to different display panels thereby saving cost for the source driver integrated circuit to change the internal resistance.

### BRIEF DESCRIPTION OF THE DRAWINGS

FIG. 1 is a schematic diagram of a structure of external Gamma resistors as known;

FIG. 2 is a schematic diagram of a structure of a Gamma resistor adjusting device of a first embodiment of the present disclosure;

FIG. 3 is a schematic diagram of a structure of a built-in resistor string of a second embodiment of the present disclosure;

FIG. 4 is a schematic diagram of a structure of Gamma resistors of a second embodiment of the present disclosure;

FIG. 5 is a schematic diagram of a structure of a source driver integrated circuit of a third embodiment of the present disclosure;

FIG. 6 is a schematic diagram of a structure of a display device of a fourth embodiment of the present disclosure;

FIG. 7 is a schematic diagram of a structure of a display device of a fifth embodiment of the present disclosure;

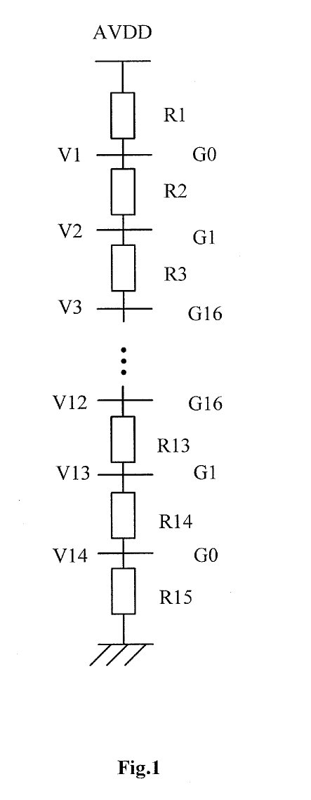

### DETAILED DESCRIPTION

In order to solve the problem of poor display picture quality of the display panel due to a mismatch of the internal resistances of the source driver integrated circuit with the display panel, in the embodiments of the present disclosure, the resistance values of the internal resistances of the source driver integrated circuit are set as an adjustable structure, so that the internal resistances of the source driver integrated circuit are matched with the display panel in a better way and the Gamma curve is smoother to achieve a better effect of picture quality. Furthermore, the same source driver integrated circuit is applicable to different display panels thereby saving cost for the source driver integrated circuit to change the internal resistance.

The specific implementations of the present disclosure will be a further described in detail in combination with the accompanying drawings and the embodiments.

### First Embodiment

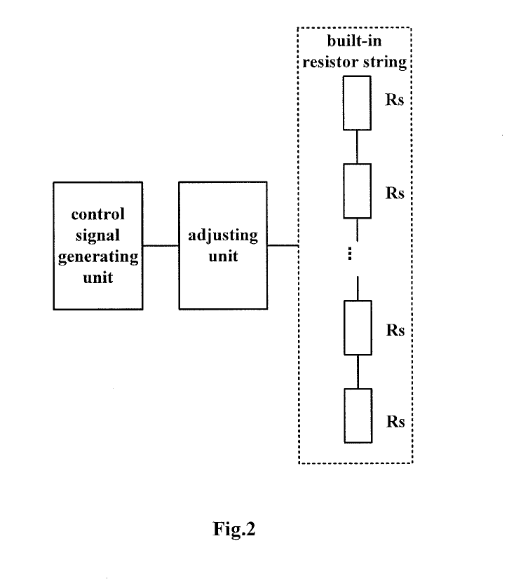

FIG. 2 is a schematic diagram of a structure of a Gamma resistor adjusting device of a first embodiment of the present disclosure. As shown in FIG. 2, the Gamma resistor adjusting device is applicable to a source driver integrated circuit and comprises a built-in resistor string, a control signal generating unit and an adjusting unit.

The built-in resistor string comprises a plurality of Gamma resistors Rs connected in series, where the Gamma resistors Rs are able to adjust resistance values thereof under the control of a control signal. Herein, the quantity of the Gamma resistors Rs connected in series are related to color scales of the display panel corresponding to the source driver integrated circuit. For example, when the gray level of the display panel corresponding to the source driver integrated circuit is n, the quantity of the Gamma resistors Rs connected in series is 2n+1. For instance, when the gray level of the display panel corresponding to the source driver integrated circuit is 64, the quantity of the Gamma resistors connected in series is 129; when the gray level of the display panel is 256, the quantity of the Gamma resistors Rs connected in series is 513.

The control information generating unit is used for receiving internal resistance variation data including resistance adjustment information of each of the Gamma resistors Rs and generating a control signal for each of the Gamma resistors Rs according to the internal resistance variation data. The resistance adjustment information of each of the Gamma resistors Rs included in the internal resistance variation data may be a resistance value of each of the Gamma resistors Rs, or may be other control information generated according to the resistance value of each of the Gamma resistors Rs. The resistance value of each of the Gamma resistors Rs is obtained by simulating according to the V-T (voltage and transmittance) curve and the Gamma curve of the display panel.

The adjusting unit is used for adjusting the resistance value of each of the Gamma resistors Rs according to the generated control signal.

Since the resistance values of respective Gamma resistors Rs in the built-in resistor string can be adjusted according to the input internal resistance variation data, the resistance values of the internal resistances of the source driver integrated circuit can be conveniently adjusted to be matched with the display panel only if the input internal resistance changing date is changed, so that the use of one source driver integrated circuit is applicable to any display panel, thereby saving cost for the source driver integrated circuit to change the internal resistance and achieving a better effect of picture quality.

### Second Embodiment

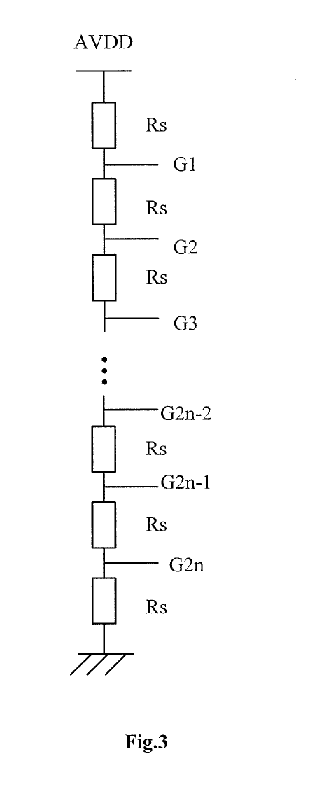

FIG. 3 is a schematic diagram of a structure of a built-in resistor string of a second embodiment of the present disclosure. As shown in FIG. 3, the built-in resistor string comprises 2n+1 Gamma resistors Rs connected in series and 2n voltage dividing nodes G1˜G2n, where n is the gray level of the display panel. In the figure, AVDD is an analog voltage for supplying power to the Gamma resistors Rs.

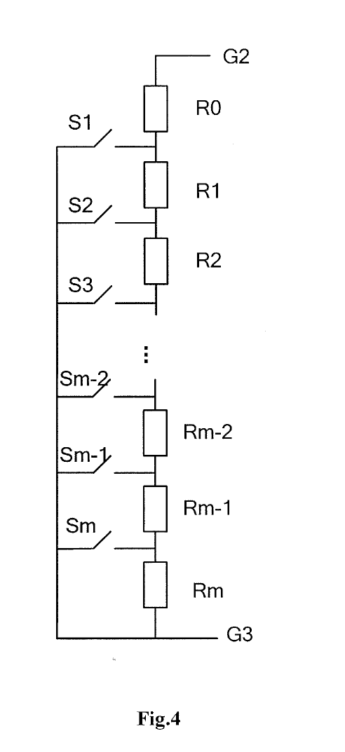

FIG. 4 is a schematic diagram of a structure of Gamma resistors of a second embodiment of the present disclosure. As shown in FIG. 4, each of the Gamma resistors Rs comprises:

a basis value resistor R0, m adjusting resistors R1˜Rm and m control switches S1˜Sm corresponding one-to-one with the m adjusting resistors R1˜Rm, where the basis value resistor R0 is connected in series with the m adjusting resistors R1˜Rm and each of the control switches is connected in parallel with the corresponding adjusting resistors, and where the value of m can be set as required. The resistance values of the adjusting resistors R1˜Rm may be or may not be equal to each other.

The adjusting unit is used for controlling the m control switches S1˜Sm to be switched on or off according to the generated control signal so as to adjust the resistance value of each of the Gamma resistors Rs.

For example, assuming that the resistance value of the basic value resistor R0 is 100 ohm, and the resistance value of each of the adjusting resistors R1˜Rm is 10 ohm, and further assuming that the internal resistance variation data inputted to the Gamma resistor adjusting device indicates that it is needed to adjust the resistance value of the Gamma resistor Rs between the voltage dividing nodes G2 and G3 to 110 ohm, then the Gamma resistor adjusting device will generate a corresponding control signal according to the internal resistance changing signal to control the control switch S2 in the Gamma resistor Rs between the voltage dividing nodes G2 and G3 to be switched on and to control the switch S1 to be switched off, so that the resistance value of the Gamma resistor Rs between the voltage dividing nodes G2 and G3 is adjusted to 110 ohm.

The implementation of the built-in resistor string in the above embodiment is simple, and the cost is relatively low.

It is needed to specify that the structure of the built-in resistor string in the above embodiment is only one form of the structure of the built-in resistor string of the present disclosure. In other embodiments of the present disclosure, the built-in resistor string may also be other structure forms as long as it can adjust the resistance value thereof under the control of the control signal.

### Third Embodiment

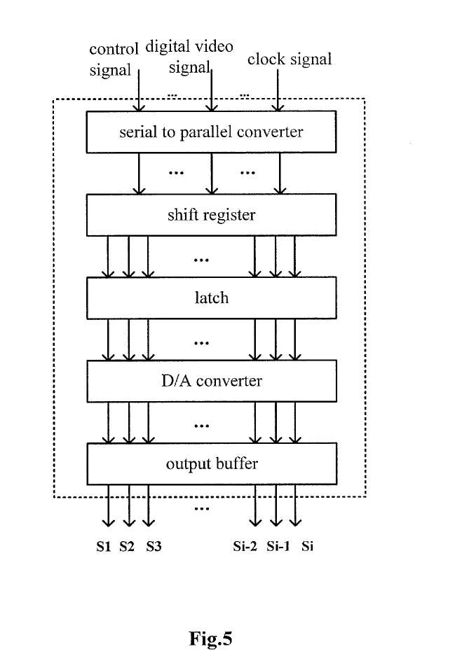

FIG. 5 is a schematic diagram of a structure of a source driver integrated circuit of a third embodiment of the present disclosure. As show in FIG. 5, the source driver integrated circuit comprises a serial to parallel converter, a shift register, a latch, a D/A converter and an output buffer. The operating mode of the source driver integrated circuit is as follows: the serial to parallel converter performs a serial to parallel conversion on an input digital video signal after having received the digital video signal to obtain a converted digital video signal and output the converted digital video signal to the shift register; the shift register performs a shifting process on the converted digital video signal to obtain a shifted digital video signal and output the shifted digital video signal to the latch; the latch performs a latching process on the shifted digital video signal to obtain a latched digital video signal and output the latched digital video signal to the D/A converter; the D/A converter converts the latched digital video signal into an analog signal (i.e., a gray-scale voltage) and outputs the gray-scale voltage to data lines S1˜Si on the display panel through the output buffer.

The source driver integrated circuit further comprises a Gamma resistor adjusting device, which may be the Gamma resistor adjusting device in any one of the above embodiments. The built-in resistor string in the Gamma resistor adjusting device may be arranged in the D/A converter and is used for performing a voltage dividing process on Gamma reference voltages V1˜V14 according to the input digital video signal to obtain the gray-scale voltage.

### Fourth Embodiment

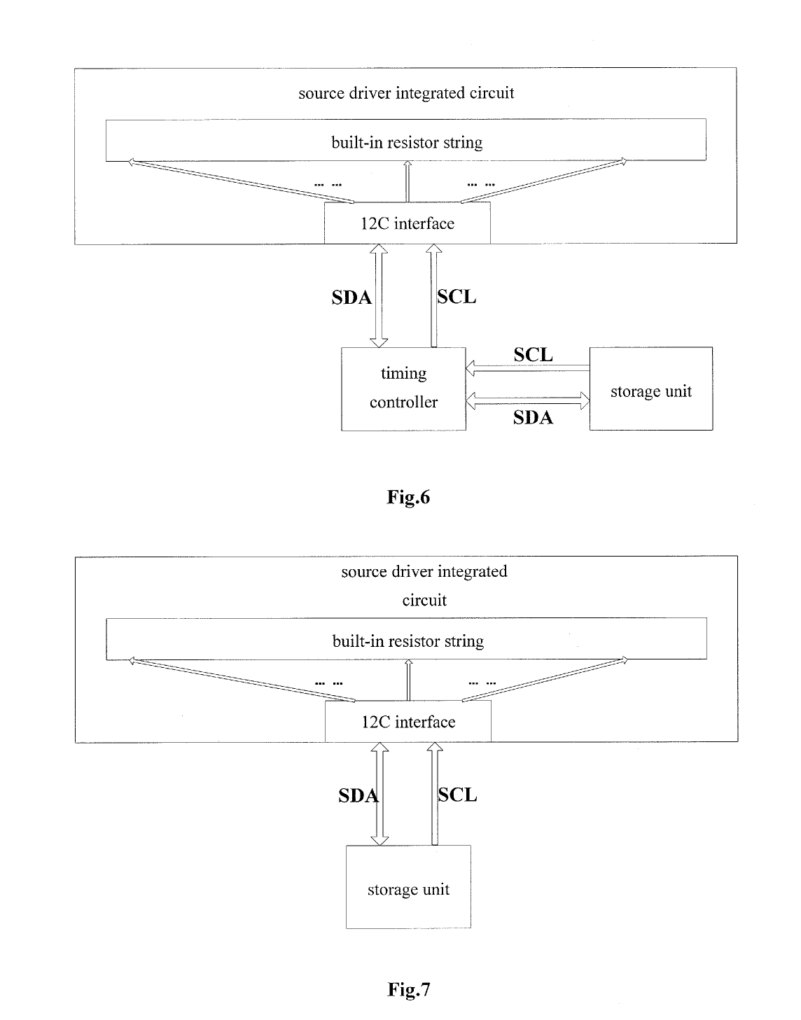

FIG. 6 is a schematic diagram of a structure of a display device of a fourth embodiment of the present disclosure. As shown in FIG. 6, the display device comprises a source driver integrated circuit, a storage unit, and a timing controller.

The structure of the source driver integrated circuit is the same as those in the above embodiments.

The storage unit is used for storing internal resistance variation data. The storage unit may be an EEPROM. The internal resistance variation data is obtained by simulating according to the V-T curve and the Gamma curve of the display panel of the display device.

The timing controller is connected with the storage unit and the source driver integrated circuit, and is used for outputting the internal resistance variation data input from the storage unit to the source driver integrated circuit when the display device operates. The timing controller is connected with the source driver integrated circuit through an internal integrated circuit interface (I2C) of the source driver integrated circuit. Of course, in other embodiments of the present disclosure, the timing controller may also be connected with the source driver integrated circuit through other types of data interfaces, such as a serial peripheral interface and the like.

In the embodiments of the present disclosure, the resistance values of respective Gamma resistors in the built-in resistor string can be simulated according to the V-T curve and the Gamma curve of the display panel, so as to obtain compensation values of respective Gamma resistors (i.e., the magnitude of the resistance values of respective Gamma resistors which needs to be adjusted). Assuming that the resistance values of the adjusting resistors in the respective Gamma resistors are equal to each other and are the minimum adjustment units, at this time, internal resistance correction coefficients of respective Gamma resistors can be obtained by dividing the compensation values of respective Gamma resistors by the minimum adjustment unit value and can be burned into the storage unit with a certain data format. When the display device operates normally, the source driver integrated circuit will read the internal resistance correction coefficient in the storage unit and generate a control signal according to the internal resistance correction coefficient to be applied to the respective Gamma resistors, so as to achieve the correction of the resistance value of the built-in resistor string.

In addition, in other embodiments of the present disclosure, the compensation values of respective Gamma values can also be burned directly to the storage unit and processed by the timing controller or the source driver integrated circuit to obtain the internal correction coefficients of the respective Gamma resistors.

In the embodiment of the present disclosure, the internal resistance variation data can be input to the timing controller by the storage unit, and then be input to the source driver integrated circuit by the timing controller, which conveniently and simply realizes the change of the internal resistances of the source driver integrated circuit, so that the internal resistances of the source driver integrated circuit are matched with the display panel in a better way and the Gamma curve is smoother thereby achieving a better effect of picture quality.

### Fifth Embodiment

FIG. 7 is a schematic diagram of a structure of a display device of a fifth embodiment of the present disclosure. As shown in FIG. 7, the display device comprises a source driver integrated circuit and a storage unit.

The structure of the source driver integrated circuit is the same as those in the above embodiments.

The storage unit is used for storing internal resistance variation data and inputting the internal resistance variation data to the source driver integrated circuit when the display device operates. The storage unit may be an EEPROM. The internal resistance variation data is obtained by simulating according to the V-T curve and the Gamma curve of the display panel of the display device. The storage unit is connected with the source driver integrated circuit through the internal integrated circuit interface of the source driver integrated circuit. Of course, in other embodiments of the present disclosure, the storage unit may also be connected with the source driver integrated circuit through other types of data interfaces, such as a serial peripheral interface and the like.

The structure of the present embodiment is generally applicable to the display device that the timing controller is integrated inside the source driver integrated circuit.

In the embodiment of the present disclosure, the internal resistance variation data is directly input to the source driver integrated circuit through the storage unit, which conveniently and simply realizes the change of the internal resistance of the source driver integrated circuit, so that the internal resistances of the source driver integrated circuit are matched with the display panel in a better way and the Gamma curve is smoother, thereby achieving a better effect of picture quality.

The display device in the above embodiments may be various types of display devices, such as a TFT liquid crystal display device.

The above descriptions are just optional and exemplary embodiments of the present disclosure. It should be noted that various improvements and modifications can be made without departing from the principle of the present disclosure for those skilled in the art and these improvements and modifications shall be deemed as falling into the protection scope of the present disclosure.

1. A Gamma resistor adjusting device, comprising:
a built-in resistor string comprising a plurality of Gamma resistors connected in series, wherein the Gamma resistors can adjust resistance values thereof under the control of a control signal;
a control signal generating unit for receiving internal resistance variation data including resistor adjustment information of each of the Gamma resistors, and generating a control signal for each of the Gamma resistors according to the internal resistance variation data; and
an adjusting unit for adjusting the resistance value of each of the Gamma resistors according to the generated control signal.

2. The Gamma resistor adjusting device according to claim 1, wherein
the Gamma resistors further comprise: a base value resistor, a plurality of adjusting resistors and a plurality of control switches corresponding to the plurality of adjusting resistors, wherein the basic value resistor is connected in series with the plurality of adjusting resistors and each of the control switches is connected in parallel with the corresponding adjusting resistor; and
the adjusting unit is further used for controlling the control switches to be switched on or off according to the generated control signal.

3. The Gamma resistor adjusting device according to claim 1, wherein the number of the Gamma resistors connected in series is 2n+1, where n is gray level of the display panel.

4. The Gamma resistor adjusting device according to claim 3, wherein the internal resistance variation data is obtained by simulating according to characteristics of voltage-transmittance curve and Gamma curve of the display panel.

5. A source driver integrated circuit comprising the Gamma resistor adjusting device according to claim 1.

6. A display device comprising the source driver integrated circuit according to claim 5.

7. The display device according to claim 6, further comprising:
a storage unit connected to the source driver integrated circuit, for storing the internal resistance variation data and inputting the internal resistance variation data to the source driver integrated circuit when the display device operates.

8. The display device according to claim 7, wherein the storage unit is connected to the source driver integrated circuit through an internal integrated circuit interface.

9. The display device according to claim 6, further comprising:
a storage unit for storing the internal resistance variation data;
a timing controller connected to the storage unit and the source driver integrated circuit, for outputting the internal resistance variation data input from the storage unit to the source driver integrated circuit when the display device operates.

10. The display device according to claim 9, wherein the timing controller is connected to the source driver integrated circuit through an internal integrated circuit interface.

11. The source driver integrated circuit according to claim 5, wherein the Gamma resistors further comprise: a base value resistor, a plurality of adjusting resistors and a plurality of control switches corresponding to the plurality of adjusting resistors, wherein the basic value resistor is connected in series with the plurality of adjusting resistors and each of the control switches is connected in parallel with the corresponding adjusting resistor; and
the adjusting unit is further used for controlling the control switches to be switched on or off according to the generated control signal.

12. The source driver integrated circuit according to claim 5, wherein the number of the Gamma resistors connected in series is 2n+1, where n is gray level of the display panel.

13. The source driver integrated circuit according to claim 12, wherein the internal resistance variation data is obtained by simulating according to characteristics of voltage-transmittance curve and Gamma curve of the display panel.
